(19) United States
(12) Patent Application Publication
(10) Pub. No.: US 2003/0160761 A1
(43) Pub. Date: Aug. 28, 2003

(54) Joystick having pressure-activated switch

(76) Inventor: Donald Wu, Taipei (TW)

Correspondence Address: BACON & THOMAS, PLLC, 625 SLATERS LANE, FOURTH FLOOR, ALEXANDRIA, VA, 22314

(21) Appl. No.: 10/079,554

(22) Filed: Feb. 22, 2002

(51) Int. Cl. G09G 5/08

(52) U.S. Cl. 345/161

(57) ABSTRACT

A joystick having pressure-activated switch mounted on an electronic device comprises an upper stick section, including a stick projected vertically, and a lower switch section, including a disk-shaped elastic piece having a convex top surface and a bottom surface corresponding to two contacts of a circuit board, so that user can manipulate stick to move cursor on display of a computer to a desired direction. In manipulating the stick, the elastic piece is pressed down to form a circuit by the contacts of the circuit board and the elastic piece for generating an input signal.

### FIELD OF THE INVENTION

The present invention relates to joystick and more particularly to an improved joystick having pressure-activated switch.

### BACKGROUND OF THE INVENTION

A conventional joystick as shown in FIG. 1 comprises a housing 11 including a circuit board 12 on a bottom having a plurality of contacts 121, a disk 13, a stick 15 extended upward vertically from a center on top of disk 13 through a top opening 16 of housing 11, a shaft 17 extended downward vertically from a center on underside of disk 13, a cup-shaped member 18 on circuit board 12 for receiving a bottom end of shaft 17 so that shaft 17 may pivot about cup-shaped member 18 for tilting stick 15 in any desired direction, an elastic ring 19 covered on disk 13, and a ring-shaped conductive rubber 110 between disk 13 and circuit board 12 wherein a tilted stick 15 can cause conductive rubber 110 to electrically contact a contact 121 on circuit board 12 for generating a signal to execute a software.

However, only a movement of cursor is made possible by the running software of the prior art joystick device. As to other input operations, there is no such provision. Hence, a keyboard in cooperation with the joystick is required if an input is desired. This means that user has to manipulate joystick with one hand and operate keyboard with the other hand. It is disadvantageous for inconvenience and low operation speed. Thus improvement exists in order to overcome the above drawbacks of prior art.

### SUMMARY OF THE INVENTION

It is therefore an object of the present invention to provide a joystick having pressure-activated switch mounted on an electronic device. The joystick comprises an upper stick section including a stick projected vertically so that user can manipulate stick to move cursor on display of a computer to a desired direction; and a lower switch section including a disk-shaped elastic piece having a convex top surface, a bottom of the elastic piece corresponding to two contacts of a circuit board. In manipulating the stick, the elastic piece is pressed down to form a circuit by the contacts of the circuit board and the elastic piece for generating an input signal.

The above and other objects, features and advantages of the present invention will become apparent from the following detailed description taken with the accompanying drawings.

### BRIEF DESCRIPTION OF THE DRAWINGS

FIG. 1 is a cross-sectional view of a conventional joystick;

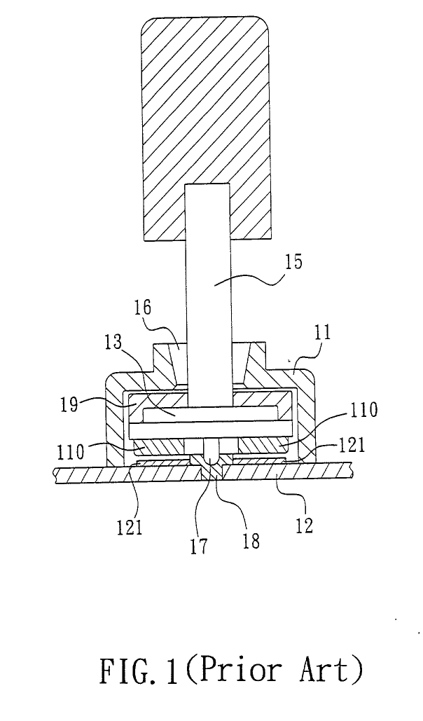

FIG. 2 is an exploded view of a preferred embodiment of joystick having pressure-activated switch according to the invention; and

FIG. 3 is a cross-sectional view of FIG. 2 joystick.

### DETAILED DESCRIPTION OF THE PREFERRED EMBODIMENTS

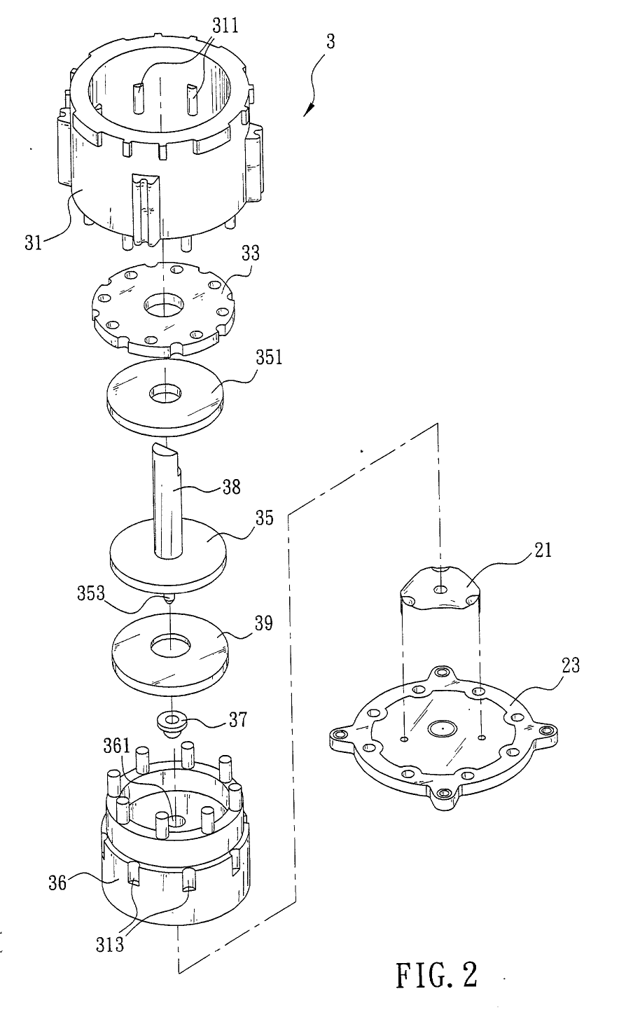

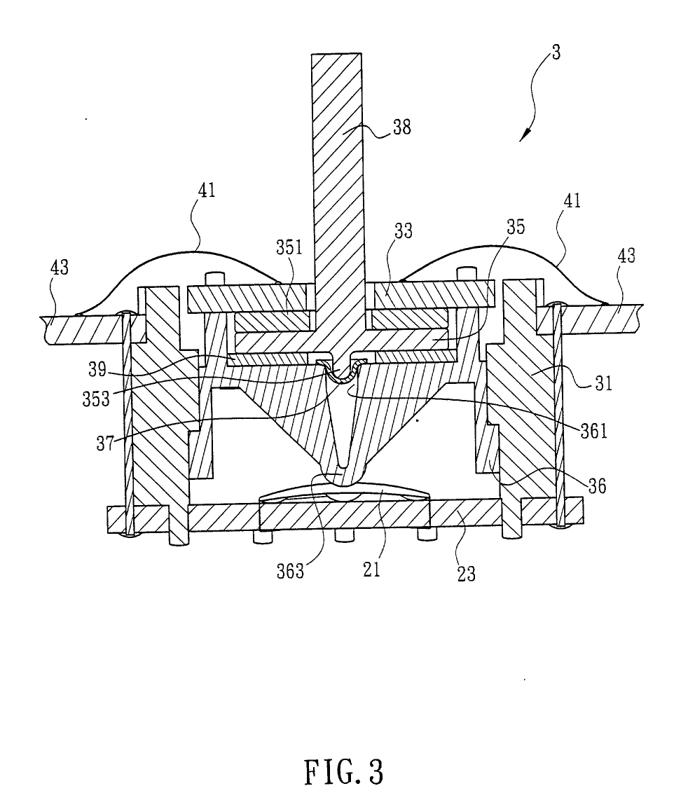

Referring to FIGS. 2 and 3, there is shown a joystick 3 constructed in accordance with the invention. Joystick 3 is provided on an electronic device such as keyboard, remote control, etc. Joystick 3 comprises a sleeve 31 having a receiving space including an upper stick section and a lower switch section therein. Stick section comprises a disk-shaped upper circuit board 33 having a center opening, a disk-shaped abutment member 35, and a sliding seat 36. Upper circuit board 33 is provided on top of sliding seat 36. A circuitry and a plurality of contacts are formed on underside of upper circuit board 33. The circuitry has conductors 41 coupled to circuit board 43 of the electronic device. Abutment member 35 in sleeve 31 is below upper circuit board 33 by a distance. A disk-shaped conductive rubber 351 having a center opening is provided on top of abutment member 35 corresponding to the contacts of upper circuit board 33. A stick 38 is extended upward vertically from a center on top of abutment member 35 through the openings of conductive rubber 351 and upper circuit board 33. Thus, it is possible of tilting stick 38 to cause conductive rubber 351 to electrically contact a contact on upper circuit board 33 for enabling upper circuit board 33. As a result, a signal is generated. Further, in the sleeve 31 the sliding seat 36 is located below abutment member 35.

Switch section comprises a disk-shaped elastic piece 21 having a convex top surface and a lower circuit board 23 provided on a bottom of sleeve 31,lower circuit board 23 having a circuitry and two contacts on top. Elastic piece 21 is formed of conductive material. Elastic piece 21 is located between sliding seat 36 and lower circuit board 23 and corresponds to the contacts of lower circuit board 23 in which one contact of lower circuit board 23 contacts the elastic piece 21. Underside 363 of sliding seat 36 contacts a top of elastic piece 21 so that elastic piece 21 can exert an elastic force onto underside 363 of sliding seat 36 for maintaining it at a predetermined height in an inactivated state of joystick 3. To the contrary, tilt stick 38 can press elastic piece 21 down through sliding seat 36. Also, a circuit is formed by two contacts of lower circuit board 23 and elastic piece 21. As a result, an input signal is generated.

By above configuration, user can manipulate stick 38 of joystick 3 to move cursor to a desired option of a running software. Next, press stick 38 of joystick 3 to select the option.

In the invention, a shaft 353 is extended downward vertically from a center on underside of abutment member 35. Correspondingly, a recess 361 having a tapered end is formed on a center of sliding seat 36 for receiving shaft 353.

In the invention, in recess 361 a cup-shaped member 37 is formed on the underside of shaft 353 for supporting the shaft 353. Also, shaft 353 may pivot about cup-shaped member 37. Further, a disk-shaped balance member 39 is provided on the underside of abutment member 35 for adjusting a center of gravity of abutment member 35.

Referring to FIG. 2 specifically, a plurality of equally spaced longitudinal projections 311 are formed on the inner wall of sleeve 31. Correspondingly, a plurality of equally spaced longitudinal grooves 313 are formed on the cylindrical outer surface of sliding seat 36. Projections 311 are slidingly received in grooves 313. Accordingly, sliding seat 36 may vertically move with respect to sleeve 31. Moreover, bottoms of grooves 313 are used as stops for preventing sliding seat 36 from moving out of sleeve 31.

While the invention has been described by means of specific embodiments, numerous modifications and variations could be made thereto by those skilled in the art without departing from the scope and spirit of the invention set forth in the claims.

What is claimed is:

1. A joystick having a pressure-activated switch mounted on an electronic device, the joystick comprising:
a sleeve having a receiving space;
an upper circuit board disposed on a top of the sleeve and including a circuitry and a plurality of contacts on an underside wherein the circuitry has conductors coupled to a circuit board of the electronic device;
a disk-shaped abutment member in the sleeve below the upper circuit board by a distance;
a disk-shaped conductive rubber having a center opening on a top of the abutment member corresponding to the contacts of the upper circuit board;
a stick extended upward vertically from a center on the top of the abutment member through the openings of the conductive rubber and the upper circuit board so as to tilt the stick to cause the conductive rubber to electrically contact one of the contacts on the upper circuit board for enabling the upper circuit board to generate a signal;
a sliding seat in the sleeve being below the abutment member with the upper circuit board provided thereon;
a lower circuit board on a bottom of the sleeve and having a circuitry and two contacts on a top; and
a disk-shaped elastic piece having a convex top surface formed of conductive material, the elastic piece being located between the sliding seat and the lower circuit board and corresponding to the contacts of the lower circuit board;
wherein an underside of the sliding seat contacts a top of the elastic piece so that the elastic piece is capable of exerting an elastic force onto the underside of the sliding seat for maintaining it at a predetermined height in an inactivated state of the joystick, and the tilted stick is capable of pressing the elastic piece down through the sliding seat to form a circuit by the contacts of the lower circuit board and the elastic piece for generating an input signal.

2. The joystick of claim 1, further comprising a shaft extended downward vertically from a center on an underside of the abutment member, and a recess having a tapered end on a center of the sliding seat for receiving the shaft.

3. The joystick of claim 1, further comprising a cup-shaped member in the recess on an underside of the shaft for supporting the shaft.

4. The joystick of claim 1, further comprising a disk-shaped balance member on the underside of the abutment member.

5. The joystick of claim 1, further comprising a plurality of equally spaced longitudinal projections on an inner wall of the sleeve, and a plurality of equally spaced longitudinal grooves on an outer surface of the sliding seat so that the projections are capable of sliding in the grooves for causing the sliding seat to vertically move with respect to the sleeve wherein bottoms of the grooves serve to prevent the sliding seat from moving out of the sleeve.
